(19) United States
(12) Patent Application Publication
(10) Pub. No.: US 2005/0202879 A1
(43) Pub. Date: Sep. 15, 2005

(54) Detachable display for video console

(75) Inventors: Saied Hussaini, Miami, FL (US); Marc Iacovelli, Miami, FL (US)

Correspondence Address: Liniak, Berenato & White;Ste. 240, 6550 Rock Spring Drive, Bethesda, MD, 20817, US

(73) Assignee: INTEC, INC.

(21) Appl. No.: 10/795,218

(22) Filed: Mar. 9, 2004

(51) Int. Cl. A63F 13/00

(52) U.S. Cl. 463/47

(57) ABSTRACT

A detachable video display system that is designed to be used with various electronic devices. The system has an upper video display housing that is pivotally connected to a lower connecting member. The connecting member includes connection brackets and clips for detachably attaching the video display device to a video game console, or similar electronic device. The video display housing may be pivoted relative to the connecting member so that the video screen has a viewing position and a stored position. In a preferred embodiment, the video display device is specifically designed to attach to a gaming device such as NINTENDO's GameCube®.

### BACKGROUND OF THE INVENTION

1. Field of the Invention

The present invention relates to consumer electronics, and more particularly to a detachable, compact screen apparatus for an electronic video-processing device, such as a video game console.

2. Description of the Prior Art

Video entertainment devices are becoming increasingly popular. VCRs, DVDs, computer game consoles, and similar electronic devices are commonly found in most households today, particularly households having young children and teenagers. These devices generally have a box-shaped housing with a plurality of plugs for interfacing with multiple complementary devices. Typically, these electronic devices do not have a dedicated video display screen, and are adapted to work with conventional TV monitors. Thus the portability of these devices is often limited to the video display device to which they are connected. Moreover, most households have a limited number of televisions, and when one family member uses the television as a video display device, other family members are unable to watch conventional televised entertainment. Thus there is a need for a compact, detachable, portable video display device adapted to be used with electronic video processing devices. Such a need particularly exists for computer video game consoles such as the NINTENDO GameCube® and other similar devices.

### SUMMARY OF THE INVENTION

The present invention comprises a detachable video display system designed to be used with various electronic devices and particularly useful with computer video game consoles. In the preferred embodiment, the system has an upper video display housing that is pivotally connected to a lower connecting member. The video display housing incorporates a video display screen and two audio speakers. The connecting member includes connection brackets and clips for attaching the video display device to a video game console, or similar electronic device. The video display housing may be pivoted relative to the connecting member so that the video screen has a viewing position and a stored position. In the preferred embodiment, the video display device is adapted for specific attachment to a Ad computer video game platform such as to a NINTENDO GameCube®.

### BRIEF DESCRIPTION OF THE DRAWINGS

The objects and advantages of the invention will become apparent from a study of the following specification when viewed in light of the accompanying drawings, wherein:

FIG. 1 is a front view of a portable video display device in accordance with an exemplary embodiment of the present invention;

FIG. 2 is a rear view of the video display device;

FIG. 3 is a side view of a first side of the video display device;

FIG. 4 is a side view of a second side of the video display device;

FIG. 5 is a top view of the video display device;

FIG. 6 is a bottom view of the video display device;

FIG. 7 is a perspective view of the video display device;

FIG. 8 is a perspective view of the video display device attached to a separate electronic video device;

FIG. 9 is a rear exploded view of the of the video display device and electronic video device;

FIG. 10 is a perspective view of the video display device installed in the electronic video device;

FIG. 11 is a rear partial cut-away view of the video display device installed in the electronic video device;

FIG. 12 is a sectional view, taken along line XII-XII shown in FIG. 11, showing the release lever clip of the video display device and a corresponding recess in the electronic video device.

### DETAILED DESCRIPTION OF PREFERRED EMBODIMENTS

The preferred embodiments of the present invention will now be described with the reference to accompanying drawings.

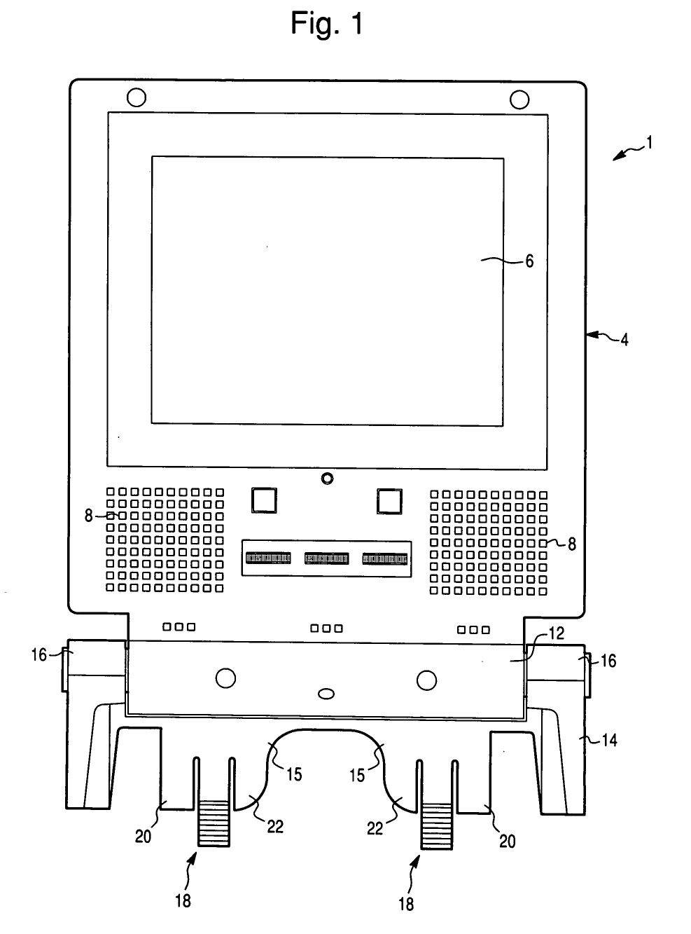

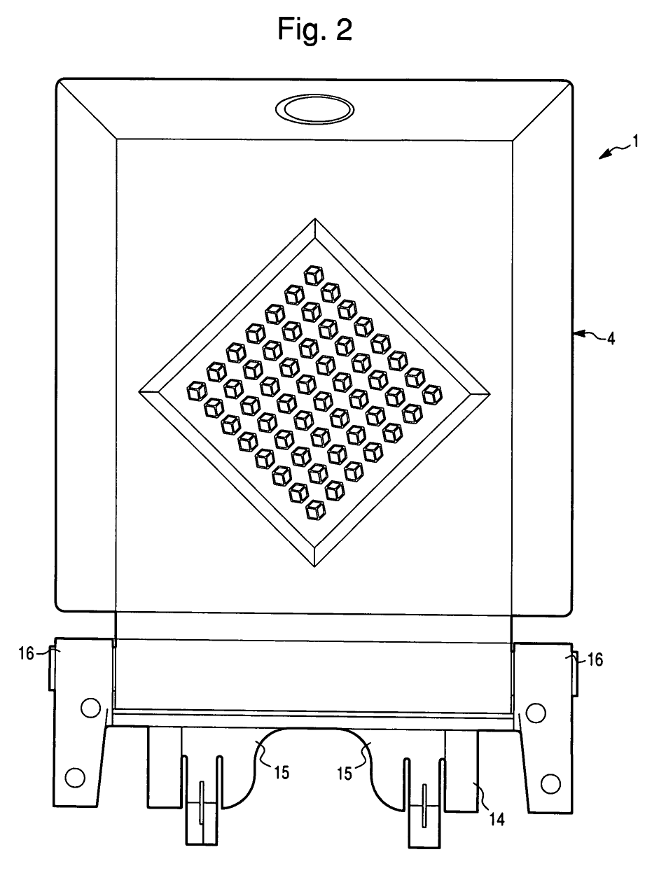

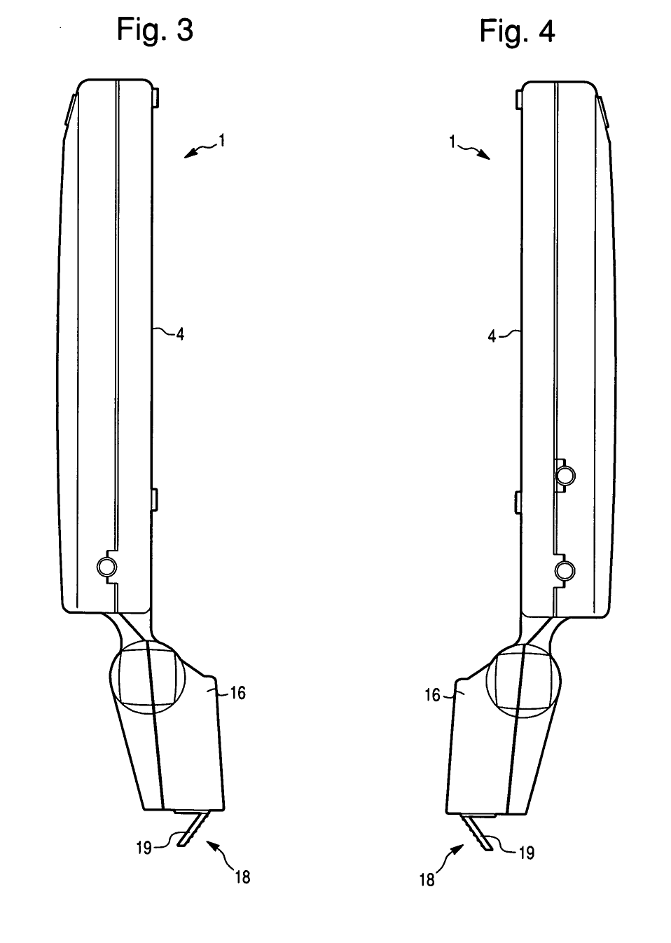

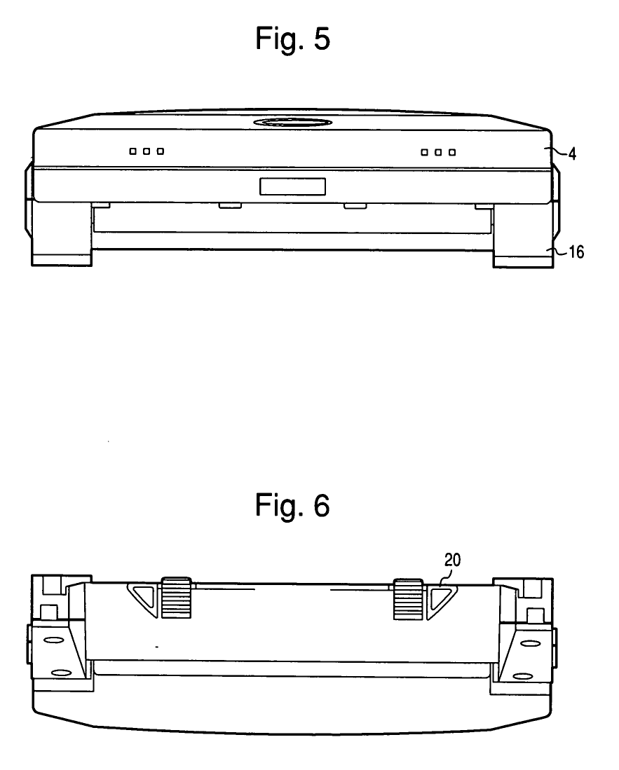

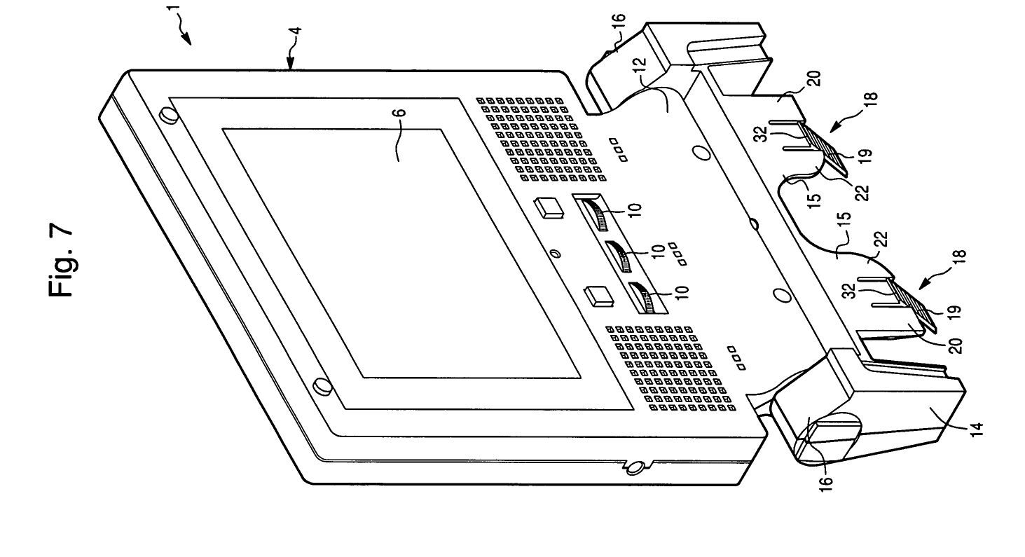

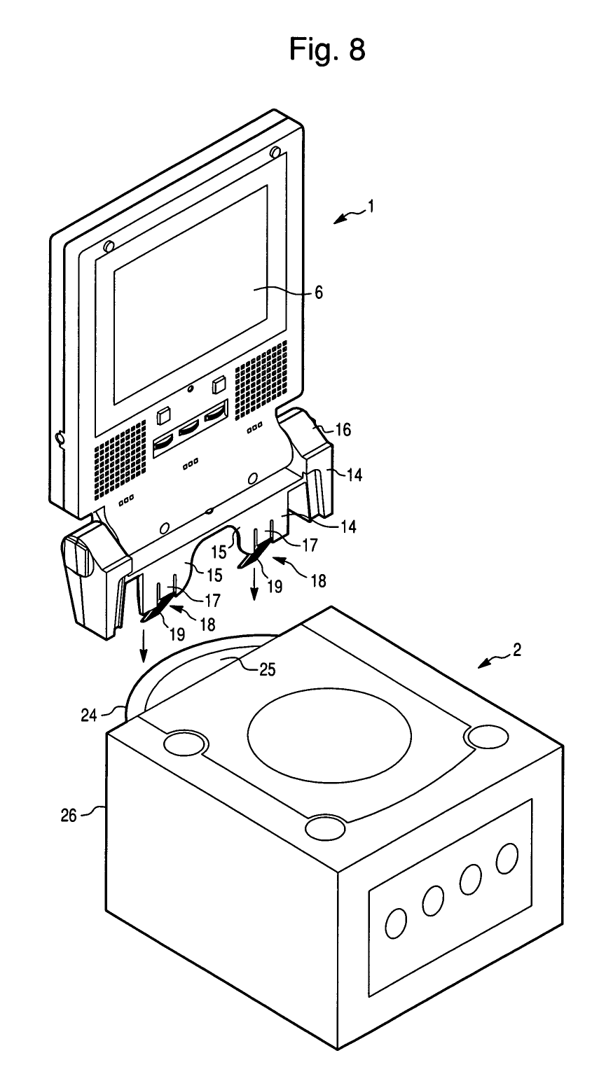

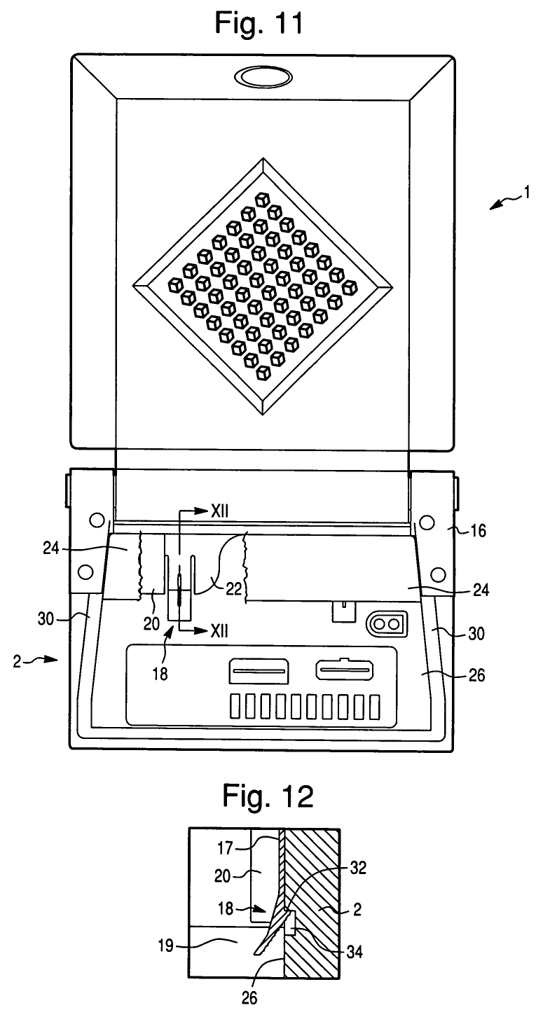

FIGS. 1-7 of the drawings illustrate an exemplary embodiment of a video display device 1 prior to attachment to an electronic signal producing device 2, such as a GameCube® game console (shown in FIGS. 8-12). As best shown in FIGS. 1 and 7, the video display device comprises a housing 4 containing a video display panel 6, preferably a liquid crystal display. The housing 4 also contains an audio system including two speakers 8, and various audio and video controls 10. The housing 4 may also include other controls and integration ports to allow the video display device 1 to connect and interface with multiple auxiliary devices.

The lower end of the housing 12 is pivotally attached to a connecting member 14. The pivotal connection allows the housing 4 to pivot at least 180° relative to the connecting member 14. The connecting member 14 is comprised of outer brackets 16 positioned on each end of the connecting member 14. Two release lever clips 18 having a cantilevered arm portion 17, tabs 19 and detents 32 are also provided to facilitate the releasibly connection which will be explained further below. Two angular brackets 20 are also provided to facilitate a snug fit between the connecting member 14 and the housing 2. As best shown in FIG. 6, the angular brackets 20 have a triangular cross-section.

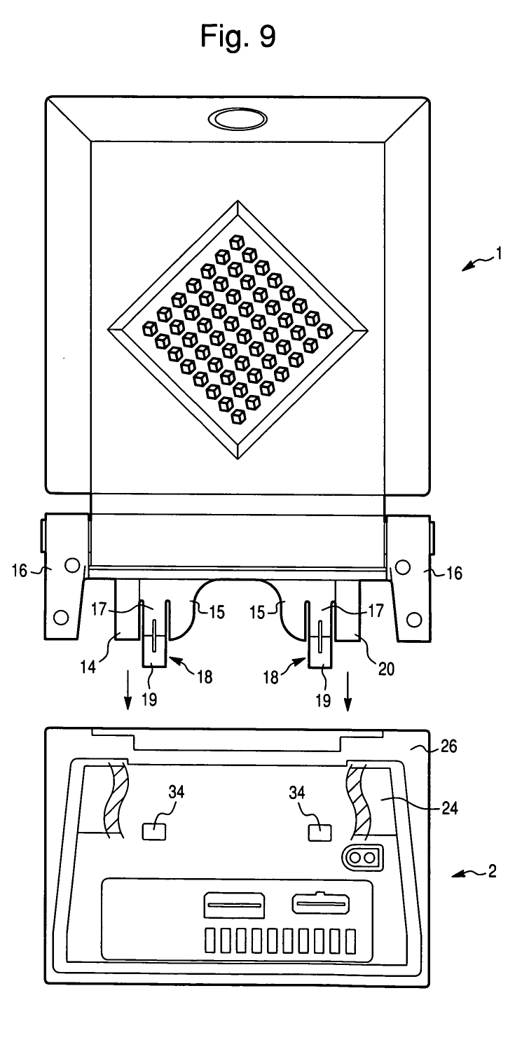

As best shown in FIGS. 8 and 9, when the video display device 1 is attached to the game console, a center portion 15 of connecting member 14 slides into a channel 25 formed between a structural member 24 and the rear surface 26 the game console. The structural member 24 is formed as a handle for carrying the game console 2.

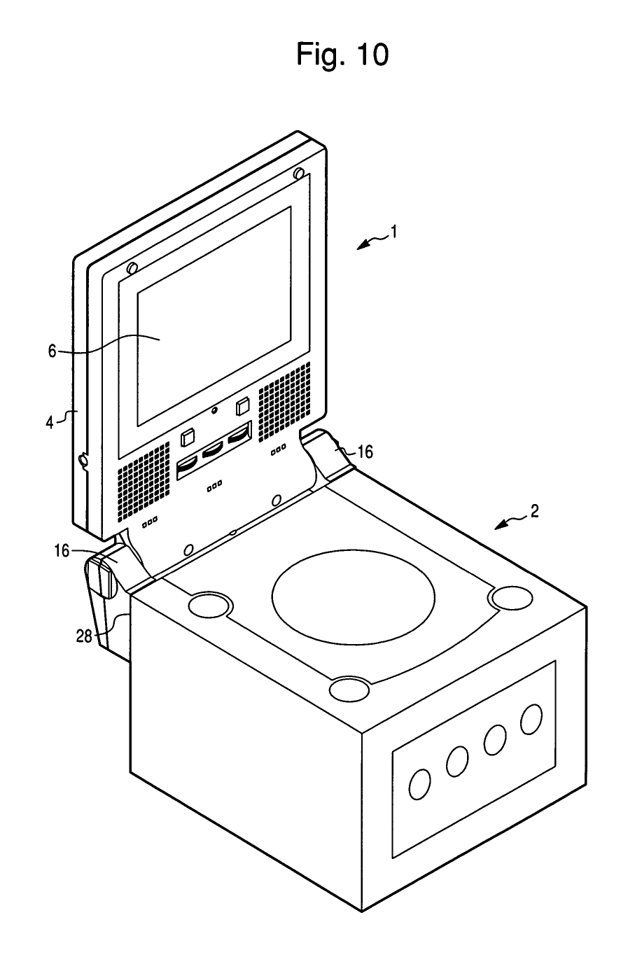

As shown in FIGS. 10-12, the video display device 1 firmly attaches to the game console 2. In the installed position, the outer brackets 16 are positioned adjacent to the upper corners 28 of the rear surface 26 of the game console 2. The outer brackets 16 also engage a ridge 30 on the game console's rear surface 26. The angular brackets 20 slide inside the handle 24 to form a frictional fit with the handle 24 and the rear surface 26 of the game console 2. The release lever clips 18 have a cantilever connection with the center portion 15 of connecting member 14 so that in the installed position, a detent 32 on the release lever clip 18 slides into a recess 34 formed on the rear surface 26 of the game console 2, as best shown in FIG. 12. The planar brackets 22 stabilize the connecting member 14 by providing an additional contact with the rear surface 26 of the game console 2.

The video display device 1 can be disengaged from the game console 2 by bending the release clips 18 away from the console 2 and lifting upward to slide the center portion 15 of the connecting member 14 out of the channel opening 25. If the user intends to leave the video display device 1 attached to the game console 2, the housing 4 can be pivoted downward so that the video display panel 6 is oriented downward adjacent to the top surface of the game console 2 in a stored position.

In operation, the video display device 1 may be mechanically connected to connected to the game console by sliding the center portion 15 of connecting member 14 into the channel 25 formed between the handle 24 and the rear surface 26 of the game console 2. Release lever clips 18 engage recesses 32 in the game console 2 to retain the connection between the video display device 1 and the game console 2. The screen housing 4 is then adjusted to a viewing position by manipulating the pivotal connection between the lower end of the housing 12 and the connecting member 14.

The video display device may be electronically connected to the game console 2 by any method known in the art such as by a single cable bundle connected through a single audio/video port in each of the video display device 1 and video signal producing device 2. Such electronic connections are well within the knowledge of one of ordinary skill in the art and need not be elaborated further. The audio/video signal is thus transmitted to the video display device 1. The display device includes conventional circuitry and components to display the video images and broadcast audio. The display device 1 may include associated controls 10 on the housing 4 to adjust the display and speaker volume. Such display panels may include LCD displays. However it is to be understood that any display device capable of displaying vide signals may be employed. The present invention is primarily directed to the releasable connection between the display device and electronic video signal-producing device. The connecting mechanism may be employed with various display devices currently available such as small LCD panel displays with built in speakers. An independent power supply may be employed to power the display device 1 or a battery compartment may be provided.

In operation, a user simply inserts the connecting member 14 with release lever clips 18 into the opening 25 in the video game device. The triangular shaped cross section of the brackets 20 are dimensioned to fit snugly between the outermost junctures of the handle 25 and rear side surface 26 of the housing 2. The front surface of the connecting member 14 substantially conforms to a corresponding portion of rear surface 26 of the housing 2 such that the two surfaces rest substantially flush against one another when connected. The detent 32 projects outward from said surface such that as the connecting member 14 is inserted into the opening 25, the cantilevered release levers 17/18 are forced backwards until the detent 32 engages the corresponding recesses 34. When the connecting member is inserted sufficiently into the opening 25, the cantilevered arm portion 17 springs back, the detents 32 engages the recesses 34, and the front surface of the connected member engages the rear surface 26 of the hosing 2. The overall arrangement provides a snug snap fit releasable connection between the display device 1 and the video signal-producing device 2. The display screen 6, may then be pivoted between a stored position whereby the display screen 6 rests substantially flush against a top surface of the video signal producing device 2, and an open position suitable to be viewed by a user. When the display device is stored flush against the top surface of the housing 2, the arrangement of the present invention provides a compact complete portable audio video device. The rotatable connection between the connecting member 14 and the display 6 preferably requires a threshold force to rotate thus facilitates the display screen 6 to be infinitely adjustable between various angular positions between the stored position and an open position. Preferably, the screen 6 may be rotated in excess of 180 degrees.

To release the video display 1 from the separate video signal producing device, a user simply inserts a finger within the opening 25 from an exposed underneath access, lifts tabs 19 forcing the detents 32 out of the corresponding recess 34 and the display device may then be simply pulled out of the opening 25 and thereby detached from the housing 2. The lift tabs 19 project acutely from the arms 17 in a direction opposite detents 32. The overall arrangement provides a detachable yet secure connection between the display 1 and electronic device 2 to positively retain the display device 1 to the housing 2.

While the present invention is described in relation to a video game console, the invention is equally suited for use with other electronic processing devices, such as DVD and VCR players, and other similar processing units producing an electronic video signal. Although the materials of construction are not described, they may include a variety of compositions consistent with the function of the invention.

The description of the preferred embodiments of the present invention has been presented for the purpose of illustration in accordance with the provisions of the Patent Statutes. It is not intended to be exhaustive or to limit the invention to the precise forms disclosed. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. This application is therefore intended to cover any variations, uses, or adaptations of the invention using its general principles. Further, this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

1. A video display device in combination with a separate video signal-producing device;
said video signal producing device comprising:
a first housing having an opening formed thereon; said video display device comprising:
a second housing containing a video display panel;
at least one connecting member projecting from said second housing, said connecting member being disposed within said opening of said first housing thereby forming a selectively releasable connection between said first housing and said second housing.

2. The combination according to claim 1, wherein said first housing includes a structural member extending across a first surface of said first housing, said opening is defined by a space between said structural member and said first surface of said first housing.

3. The combination according to claim 2, wherein said connecting member includes at least one release lever, said release lever includes a detent that engages a recess formed in said first surface of said first housing to positively connect said first housing to said second housing.

4. The combination according to claim 3 wherein said release lever is formed as a cantilever extending from said connecting member to selectively facilitate bending said release lever away from said first housing to remove said detent from said recess and release said first housing from said second housing.

5. The combination according to claim 2, wherein said structural member is formed as a curved handle adapted to be grasped by a hand of a user, said connecting member includes a body having a dimension substantially spanning a distance within said opening thereby facilitating a snug fit of said connecting member within said opening.

6. The combination according to claim 5 wherein said connecting member further comprises at least one angular bracket, said angular bracket abuts a surface of both said first housing and said curved handle when said first housing is connected to said second housing.

7. The combination of claim 6 wherein said angular bracket has a triangular shaped cross section and at least one side surface substantially conforming to a corresponding inner surface of said curved handle.

8. The combination of claim 7 wherein said connecting member comprises at least two release levers positioned between and adjacent to a corresponding one of two angular brackets.

9. The combination of claim 8 further comprising at least one planar guide extending from said connecting member, said at least one planar guide positioned between said two release levers.

10. The combination of claim 9 wherein said curved handle has a first end and a second end, said first end connects to a first point on a rear surface of said first housing, said second end connects to a second point on said rear surface of said first housing, said two angular brackets and said two release levers are disposed within said opening and adjacent said first housing between said first point and said second point.

11. The combination of claim 6 wherein said connecting member has a first outer bracket attached to a first end of said connecting member, and a second outer bracket attached to a second end of said connecting member,
said first outer bracket abuts a first corner of said first housing, and said second outer bracket abuts an oppositely disposed second corner of said first housing.

12. The combination of claim 11 wherein a vertical surface of said first and second outer brackets abut said rear surface of said first housing, and
a horizontal surface of said first and second outer brackets abuts a ridge on said rear surface of said first housing.

13. The combination of claim 1 wherein said second housing pivots at least 180° relative to said first housing.

14. The combination of claim 1 wherein said signal producing device is a self contained computer video game console, said game console being electrically connected to said video display device thereby permitting communication of audio and video signals between said video signal producing device and said video display device.

15. A video display device comprising:
a housing containing a video display panel for displaying a signal produced by an external electronic device;
a connecting mechanism extending from said housing for connecting said electronic device to said housing, said connecting mechanism comprising at least one cantilevered release lever clip having at least one locking detent.

16. The video display device according to claim 15, wherein said connecting mechanism is rotatably connected to said housing.

17. The video display device according to claim 16, wherein said at least one cantilevered release lever clip further comprises a detent extending proximate a terminal end thereof to facilitate a selective engagement with a recess of a video signal producing device and enable positive retention of said connecting mechanism to said video signal producing device.

18. The device according to claim 18, wherein said cantilevered release lever clip further includes a tab extending acutely from a cantilevered arm portion of said release lever clip in a direction substantially opposite from said detent, said tab being dimensioned to be engagable by a finger of a user to bend said cantilevered arm portion and release said detent from engagement with said recess.
